(19) United States
(12) Patent Application Publication
(10) Pub. No.: US 2005/0021544 A1
(43) Pub. Date: Jan. 27, 2005

(54) System and method for managing information

(76) Inventor: Robert Wilkins, Peterborough, NH (US)

Correspondence Address: DEVINE, MILLIMET & BRANCH, P.A., 111 AMHERST STREET, BOX 719, MANCHESTER, NH, 03105, US

(21) Appl. No.: 10/871,352

(22) Filed: Jun. 18, 2004

Related U.S. Application Data
(60) Provisional application No. 60/479,619, filed on Jun. 18, 2003.

(51) Int. Cl. G06F 7/00

(52) U.S. Cl. 707/100

(57) ABSTRACT

A system and method for managing information includes electronically recording original items of information and displaying the original items of information in an initial area as initial entries on a user's computer system. These initial entries are linked to at least one person, project and/or group. The initial entries can be assigned to at least one person, project and/or group.

### RELATED APPLICATIONS

The present application claims the benefit of provisional application Ser. No. 60/479,619 filed Jun. 18, 2003, which is incorporated herein by reference.

### TECHNICAL FIELD

The present invention relates to software for managing information and more particularly, to software for managing items of information by linking notes to one or more people and/or projects.

### BACKGROUND INFORMATION

In all types of businesses, occupations, and other activities, people write down information or take notes. Notes are taken in virtually any location such as during a business meeting, at a desk, on the run, or at home. Notes are recorded in various ways such as on paper (e.g., on sticky notes or in a time management diary) or on an electronic device (e.g., a desktop PC, a laptop, or a handheld device with a notepad software).

Often, notes are taken to remind us to take some action or to have someone else take some action. Thus, recording the note is usually only half of the solution. The other half, and perhaps the most difficult, is the follow-up action that needs to be taken based on the information in the note. The previous ways of recording notes often do not facilitate the follow-up action. When a note is recorded on paper or electronically, the note remains in one location, requiring the note taker to remember where the information was recorded before any follow-up action can be taken.

To avoid this problem, some individuals often manually organize notes on an electronic device by filing the notes according to the most appropriate person or project. When it is time to take an action, the note taker will recall the information, for example, by opening the file folder corresponding to the person or project. Where information must be related to multiple people or projects, however, this manual organization of information is inefficient and may not be possible. Also, this manual organization of information often does not allow the information to be retrieved quickly, for example, when a person related to a note calls.

Some software programs have attempted to allow information to be related by linking a contact with a note or other piece of information through the use of popup boxes or forms. These programs, however, are primarily contact managers and everything is based on a conversation or follow up task with a person or contact. These programs were not designed as note taking programs. Before the user can take a note using these programs, the user must first locate the contact and enter some information. Other existing programs display a pop-up module box asking the user to search for information to be linked. In most of these programs, the information can only be linked to a contact or person.

As a result, these programs do not allow notes to be taken quickly and intuitively and are not conducive to the note taking process. In a meeting where numerous notes are taken related to various people and/or projects, for example, the contact manager programs are not efficient because the note taker does not have time to search for a contact, enter the required information into a popup window, and keep up with the meeting. These programs are also not conducive to taking short, quick notes, such as a quick telephone message.

Moreover, the existing programs do not allow the information to be easily retrieved without first locating a contact or person and searching the information linked to the contact or person. To facilitate the follow up action, the information should be easily accessible from many different sources and the information should be easy to re-arrange to fit a user's particular situation or working style.

Furthermore, the existing programs do not provide a note taking application that allows notes to be sent directly to the note taking applications of other users. The use of standard e-mail programs to send notes and assign tasks to other people is inefficient and often results in important information being lost among other unimportant e-mail messages.

Accordingly, there is a need for a system and method for managing information that automatically links the information to one or more people and/or projects and facilitates reviewing the information, taking action on the information, and sharing the information with someone else.

### SUMMARY

In accordance with one aspect of the present invention, a method for managing information includes the steps of: electronically recording original items of information; displaying the original items of information in an initial area as initial entries; and linking the items of information to at least one person or project.

Some embodiments may include one or more of the following. Where the initial area is a journal area. Where the step of recording items of information further includes entering the information using a device. The step of displaying also includes displaying the items of information in outline form. Where displaying further includes indicating the status of the items. Where linking further includes qualifying the item as pending items for the linked at least one person or project. The step of linking includes linking to at least one group of people or projects. Where displaying includes displaying pending items in a pending area corresponding to the person or project. Where the pending item displayed in the pending area is a mirror copy of the item displayed in the initial area as the initial entries. Some embodiments may include the step of assigning the pending item in response to a user action such that the pending item becomes an assigned item for the linked person or object. Other embodiments may include where the assigned item is linked to a different person or project such that the assigned item is initially qualified as a pending item for the different person or project, and further, where recording a new information item in the assigned area corresponds to at least one person or project, and hot linking the items of information while the items of information are recorded.

In some embodiments, the step of recording further includes manually linking the item of information, and in some embodiment, the new information item is liked to another person or project and is initially qualified as a pending item for the other linked person or project.

In accordance with one aspect of the present invention, a method for managing information includes the steps of: electronically recording original items of information; displaying the original items of information in a journal area as journal entries; and hot linking the items of information to at least one person or project.

Some embodiments may include one or more of the following. The hot linking may include hot linking to at least one group of people or projects. The recording step may include receiving at least one hot key character and hot key designation and automatically linking the original item to the at least one person, project or group associated with the hot key character and hot key designation. Hot key text may be associated with the hot key character and hot key designation such that the hot key designation is replaced with the hot key text when the hot key designation is received.

In accordance with one aspect of the present invention, a method for managing information includes the steps of: electronically recording original items of information; displaying the original items of information in a journal area as journal entries; linking the items of information to at least one person or project; assigning at least one of the items of information to the linked person or project in response to a user action; and displaying the assigned items in an assigned area corresponding to the linked person or project.

Some embodiments may include where the assigned area allows the assigned item to be edited and provides a link from the assigned item back to the original item remaining in the journal area.

In accordance with one aspect of the present invention, a method for managing information on a user's computer system includes the steps of: electronically recording original items of information entered into the computer system; displaying the original items of information in a journal area on the user's computer system; linking the items of information to at least one person or project; and assigning and sending at least one of the items of information to a recipient at another computer system.

Some embodiments may include one or more of the following. The assigned item may be displayed in an inbox of the user's computer system until received by said recipient. The method may additionally include the steps of displaying the assigned item in a pending area of the user's computer system until the assigned item is accepted by recipient; in response to the recipient accepting the assigned item, moving the assigned item to an assigned area on the user's computer system; and in response to the recipient rejecting the assigned item, displaying the assigned item on the user's computer system with a rejection indication.

Other embodiments of the present invention include computer program products comprising code for performing the methods described above.

These aspects of the invention are not meant to be exclusive and other features, aspects, and advantages of the present invention will be readily apparent to those of ordinary skill in the art when read in conjunction with the appended claims and accompanying drawings.

### BRIEF DESCRIPTION OF THE DRAWINGS

These and other features and advantages of the present invention will be better understood by reading the following detailed description, taken together with the drawings wherein:

FIG. 1 is a flow chart illustrating a method of managing information, according to one embodiment of the present invention;

FIG. 2 is a flow chart illustrating a method of managing information, according to another embodiment of the present invention; and

FIG. 3 is a flow chart illustrating a method of managing information, according to another embodiment of the present invention.

### DETAILED DESCRIPTION OF THE PREFERRED EMBODIMENTS

To satisfy the need described above, the present invention provides a system and method for managing information. The system and method is preferably implemented using an information management software application and a computer system or device including, but not limited to, a desktop computer, a laptop computer, a Tablet PC, and a handheld device.

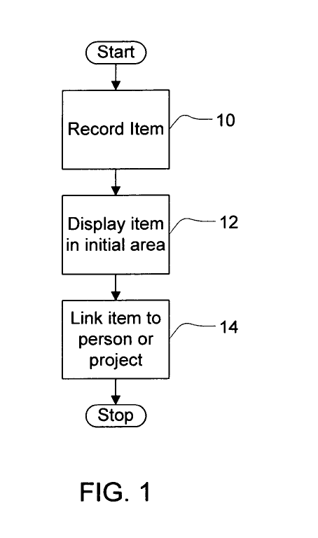

Referring first to FIG. 1, the flow chart illustrates one preferred method of managing information. In step 10, an item is recorded. The items can be recorded by entering the information into the device. One preferred step of recording the items of information includes typing the information using a keyboard or stylus or by other known methods for recording information into a computer system or device. The items of information are preferably displayed in an outline format including parent items and child items, which can be linked to people and/or objects separately. Status indicators (e.g., colors) can also be used to indicate the status of items, for example, linked pending items, linked assigned items, and completed items.

Next, in step 12, the item is displayed in an initial area. The initial area is the area where the item is recorded. Finally, in step 14, the item is linked to a person or project. The item can be linked to any number of persons, including groups, or any number of projects.

When linked, the items of information are initially qualified as pending items for the linked person or project. In the preferred embodiment of the present invention, this can all be done without any popup windows or forms to fill out, which intrude on the user's ability to take notes.

Once the items are linked to a particular person or project, the item will stay linked and associated with that person or project, no matter where that person or project is moved. Additionally, the same item can be linked to unlimited numbers of persons or projects.

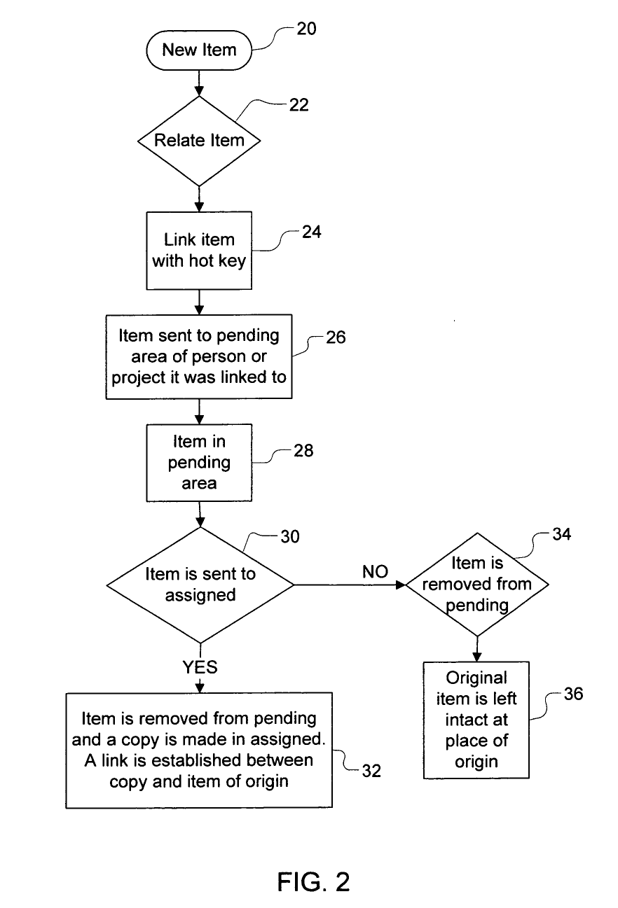

Referring now to FIG. 2, the flow chart illustrates another preferred method of managing information. In step 20, a new item is created. The item is entered in the initial area as an initial entry. However, the item can begin in the journal area, the assigned area, or other comparable area. The initial area is a note taking area, where the user enters information freely. The assigned area is a initial area for a specific assigned person or project. Next, in step 22, the item is related, and then in step 24, the item is linked with a hot key. The hot key is used to auto link the item, while the user is entering the information, to a person, project or group. The item can be linked to any number of people, projects or groups. The hot key is assigned to the person or project once, when the person or project is created. Items can be linked or related from any initial area, including the journal area and assigned area. One preferred step of linking includes hot linking the items while the items are recorded. Alternatively, an item of information can be manually linked to the person or project after recording the item of information, for example, by dragging and dropping the item to the appropriate location. One method of hot linking comprises associating hot key designations with respective people, projects, and/or groups. When recording the original item, at least one hot key character and hot key designation is received and the original item is automatically linked to the person, project or group associated with the hot key designation. The hot key designation can also have hot key text associated therewith such that the hot key designation is replaced with the hot key text when typed.

Then, in step 26, the item is sent to the pending area of all the persons or projects in which it was linked. The item is in the pending area in step 28, the pending item displayed in the pending area is, in the preferred embodiment, a mirror copy of the item displayed in the journal entry of the journal area. When the journal entry with the original item is modified in the journal area, the pending item is modified in the pending area. The pending item can be removed from the pending area or assigned to the linked person or project but preferably cannot be edited directly in the pending area. When the pending item is removed, the journal entry with the original item remains in the journal area, thus keeping the original item or note intact.

Next, in step 30, the item is sent to an assigned area. The assigned area preferably allows the assigned item to be edited and provides a link from the assigned item back to the original item remaining in the journal area.

The user assigns the pending item to any number of linked persons, projects or groups. The pending item is assigned such that the pending item becomes an assigned item for the linked person or project. The item can be assigned to any number of people, groups, or projects. The assigned items are preferably displayed in an assigned area corresponding to the linked person or project, for example, in response to a user request to view the items linked to the person or project. The pending item displayed in the pending area is preferably a mirror copy of the item displayed in the journal entry of the journal area. When the journal entry with the original item is modified in the journal area, the pending item is modified in the pending area. The pending item can be removed from the pending area or assigned to the linked person or project but preferably cannot be edited directly in the pending area. When the pending item is removed, the journal entry with the original item remains in the journal area, thus keeping the original item or note intact.

In step 32, after a pending item is assigned, in one embodiment, the pending item is removed from the pending area and the original item remains in the journal area. The assigned area preferably provides a link from the assigned item back to the original item. The assigned item can be edited in the assigned area. If in step 34 the item is removed from pending, then, in step 36, the original item is left intact at the place of origin.

When an assigned item is linked to a different person or project, the assigned item is initially qualified as a pending item for the different person or project. When a new information item is recorded in the assigned area corresponding to at least one person or project, the new information item can be linked to another person or project and is qualified as a pending item for the other linked person or project.

One preferred step of linking includes hot linking the items of information while the items of information are recorded. Alternatively, an item of information can be manually linked to the person or project after recording the item of information, for example, by dragging and dropping the item to the appropriate location.

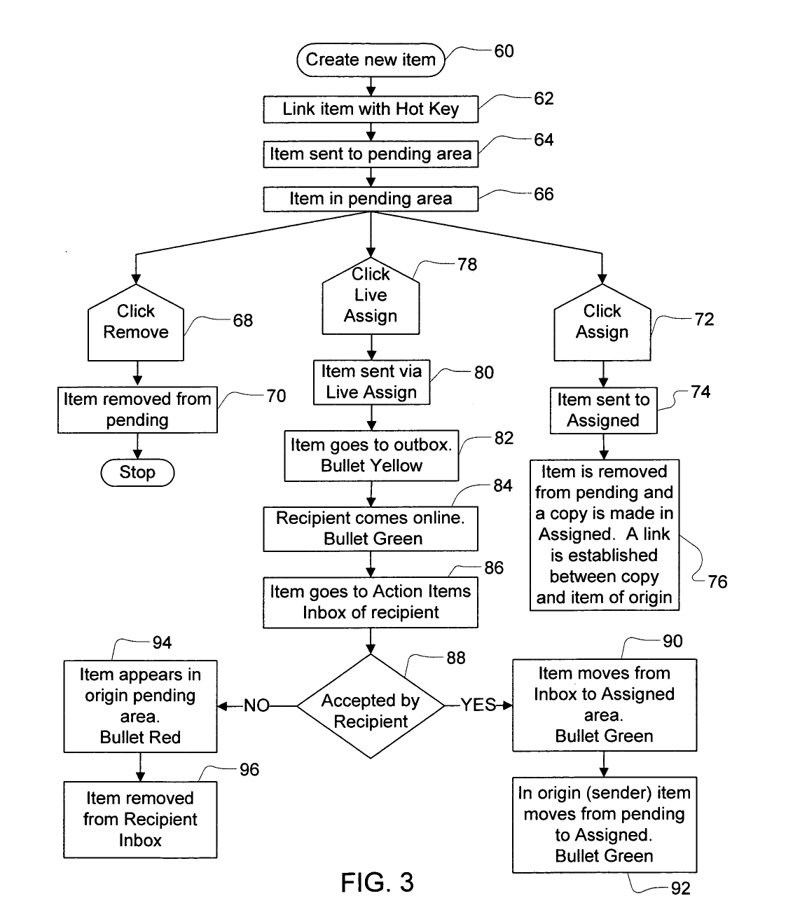

Referring to FIG. 3, the flow chart illustrates another preferred method of managing information using the flow of items from the journal area to the pending areas and assigned areas of people and projects. In step 60, a new item is created. The item is linked with a hot key in step 62. Next, the item is sent to a pending area in step 64. There are three options for the item in the pending area (step 66). First, the user can select remove, step 68, and the item is then removed from the pending area (step 70). Second, the user can selected assign (step 72). The item is then sent to the assigned area (step 74) and the item is removed from the pending are and a copy is made in the assigned area. A link is established between the copy and the item of origin (step 76). Third, the user can select Live Assign (step 78). The assigned item is preferably displayed in an outbox of the user's computer system until received by the recipient. If the recipient accepts the assigned item, the assigned item can be moved to an assigned area on the user's computer system and is preferably displayed with a color indicating acceptance. If the recipient rejects the assigned item, the assigned item is preferably displayed on the user's computer system with a color indicating rejection.

Still referring to FIG. 3, the item is sent via Live Assign (step 80) to outbox (step 82). In one embodiment, the item is displayed in an outbox of the user's computer system until received by recipient. One preferred method includes the step of displaying the assigned item in a pending area of the user's computer system until the assigned item is accepted by the recipient. In one embodiment, indicators are used to show the status of the item. For example, in step 84, once the item goes to the outbox, the item is flagged with a yellow bullet. Next, in step 86, the item goes to the ActionItems inbox of recipient. If the item is accepted by the recipient, in step 88, then the item moves from the inbox to the assigned area of the recipient's computer system. In one embodiment, the item is then flagged with a green bullet (step 90). The origin (sender) item moves from pending to assigned in step 92. In some embodiments, the item will be flagged by a green bullet.

However, if the item is not accepted by the recipient in step 88, in one embodiment, the item appears in the origin pending area flagged with a red bullet. The item is then removed, in step 96, from the recipient inbox.

In one embodiment, the method includes the step of displaying a listing of people to whom items can be assigned. The listing can include an indicator, such as a colored bullet, with the name of each person to indicate whether or not the person is on line. The listing can also include hot key designations associated with the people and the number of assigned and pending items linked to the people. The listing can also include other indications useful to the user and known and used in the art.

The journal is the primary place to record any information item. In the preferred embodiment, the notes are captured in outline form. In the preferred embodiment of the invention, an auto save feature is included, this feature can be user programmed to auto save at any interval.

To link or assign items to a person or project, person or group, the project, person or group must first be set up inside the database. Hot key information will be entered while the person, project or group is set up. A hot key is shorthand for a person, project or group. Any symbol can be used as a hot key.

The inbox displays all items that have been assigned to a user through the Live Assign option. The outbox displays all Live Assign items that are waiting to be sent or responded to by the recipient.

In one embodiment of the present invention, drag and drop is used to assign an item to a person or project that is currently showing journal. Dragging and dropping an item onto a person or project puts that item into their pending for review. Items may then be assigned from pending. Pending is a review area, where final check of an item can be made prior to officially assigning it to a person or project. Items sent to the pending area are still dynamically linked to the source item/origin in the journal. If the journal entry is amended, those changes will be reflected in the pending item. Once an item is in pending, it can either be officially assigned to a person or project, or deleted.

Text cannot be changed from inside the pending area, however, due dates and priorities may be assigned. Items can be amended for spelling or content when assigned to a person or project, or from the journal.

The Live Assign assigns items to others sharing a local network. A Live ID is required to assign an item. Like hot keys, Live IDs are created at the time a person is entered into the database.

When assigning items using the Live Assign, if the recipient is online, the item will appear in their inbox instantly. If they are off-line, it will remain in the user's outbox until the recipient is online. In one embodiment, if the recipient accepts the sent item, the status button will become green, and the item will move to its Assigned Outline. If the recipient rejects the sent item, the status button will become red, and the item will return to its pending area.

Once an item has been assigned, the one embodiment additionally includes displaying a check box to allow an item to be checked when it is completed. A due date can also be assigned to an item and displayed with the item in the upcoming view for the associated person or project. Items can also be assigned a priority and sorted according to priority. According to a further step, attachments, such as a web page or word document, can also be linked to any item.

Embodiments of the invention may be implemented in any conventional computer programming language. For example, preferred embodiments may be implemented in a procedural programming language (e.g., “C”) or an object oriented programming language (e.g., “C++” or Java). One embodiment of the software can be developed using Apple's native Unix code known as Cocoa. Another embodiment of the software can be developed for the Palm platform using C++. A further embodiment of the software can be developed for the Window's platform using Microsoft's .net development language in C sharp. Alternative embodiments of the invention may be implemented as pre-programmed hardware elements, other related components, or as a combination of hardware and software components.

Embodiments can be implemented as a computer program product for use with a computer system including, but not limited to, a PC or a mobile device. Such implementation may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or analog communications lines) or a medium implemented with wireless techniques (e.g., microwave, infrared or other transmission techniques). The series of computer instructions embodies all or part of the functionality previously described herein with respect to the system. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software (e.g., a computer program product).

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

1. A method for managing information comprising the steps of:
electronically recording original items of information;
displaying said original items of information in an initial area as initial entries; and
linking said items of information to at least one person or project.

2. The method claimed in claim 1 wherein said initial area is a journal area.

3. The method claimed in claim 1 wherein said recording items of information includes entering said information using a device.

4. The method claimed in claim 1 wherein said displaying further comprising displaying said items of information in outline form.

5. The method claimed in claim 1 wherein said displaying further comprising indicating the status of said items.

6. The method claimed in claim 1, wherein said linking further comprising qualifying said item as pending items for said linked at least one person or project.

7. The method claimed in claim 1 wherein said linking includes linking to at least one group of people or projects.

8. The method claimed in claim 6 further comprising displaying pending items in a pending area corresponding to said person or project.

9. The method claimed in claim 8 wherein said pending item displayed in said pending area is a mirror copy of the item displayed in said initial area as said initial entries.

10. The method claimed in claim 8 further comprising assigning said pending item in response to a user action such that said pending item becomes an assigned item for said linked person or object.

11. The method claimed in claim 10 wherein said assigned item is linked to a different person or project such that the assigned item is initially qualified as a pending item for said different person or project.

12. The method claimed in claim 11 further comprising recording a new information item in said assigned area corresponding to at least one person or project.

13. The method claimed in claim 12, wherein said recording further comprising hot linking said items of information while said items of information are recorded.

14. The method claimed in claim 12, wherein said recording further comprising manually linking said item of information.

15. The method claimed in claim 12, wherein said new information item is liked to another person or project and is qualified as a pending item for said other linked person or project.

16. A method of managing information comprising the steps of:
electronically recording original items of information;
displaying said original items of information in a journal area as journal entries; and
hot linking said items of information to at least one person or project.

17. The method claimed in claim 16 wherein said hot linking includes linking to at least one group of people or projects.

18. The method claimed in claim 17 wherein said recording comprising receiving at least one hot key character and hot key designation and automatically linking said original item to said at least one person, project or group associated with said hot key character and hot key designation.

19. The method claimed in claim 18 wherein said hot key text is associated with said hot key character and hot key designation such that said hot key designation is replaced with said hot key text when said hot key designation is received.

20. A method of managing information comprising the steps of:
electronically recording original items of information;
displaying said original items of information in a journal area as journal entries;
linking said items of information to at least one person or project;
assigning at least one of said items of information to said linked person or project in response to a user action; and
displaying said assigned items in an assigned area corresponding to said linked person or project.

21. The method claimed in claim 20 wherein said assigned area allows said assigned item to be edited and provides a link from said assigned item back to said original item remaining in said journal area.

22. A method of managing information on a user's computer system comprising the steps of:
electronically recording original items of information entered into said computer system;
displaying said original items of information in a journal area on said user's computer system;
linking said items of information to at least one person or project; and
assigning and sending at least one of said items of information to a recipient at another computer system.

23. The method claimed in claim 22 wherein said assigned item is displayed in an inbox of said user's computer system until received by said recipient.

24. The method claimed in claim 22 further comprising the steps of: displaying said assigned item in a pending area of said user's computer system until said assigned item is accepted by recipient; in response to the recipient accepting said assigned item, moving said assigned item to an assigned area on said user's computer system; and in response to said recipient rejecting said assigned item, displaying said assigned item on said user's computer system with a rejection indication.
